(19) United States
(12) Patent Application Publication
(10) Pub. No.: US 2011/0008560 A1
(43) Pub. Date: Jan. 13, 2011

(54) ALIPHATIC POLYESTER-BASED RESINS

(75) Inventors: Raphael Dabbous, Riehen (CH); Klaus Stoll, Binzen (DE)

Correspondence Address: BASF Corporation;Patent Department, 500 White Plains Road, P.O. Box 2005, Tarrytown, NY, 10591, US

(73) Assignee: BASF SE, Tarrytown, NY (US)

(21) Appl. No.: 12/747,537

(22) PCT Filed: Dec. 18, 2008
(86) PCT No.: PCT/EP08/67906

§ 371 Date: Sep. 16, 2010

Related U.S. Application Data
(60) Provisional application No. 61/066,310, filed on Feb. 19, 2008.

(30) Foreign Application Priority Data
Feb. 19, 2008 (EP) 07150430.2

(51) Int. Cl. C08K 5/05; B32B 1/02; B32B 1/08

(52) U.S. Cl. 428/36.9; 524/381; 524/382; 428/36.92

(57) ABSTRACT

A composition comprising the components (I) an aliphatic polyester-based resin selected from the group consisting of polyhydroxyalkanoates with 3 to 8 carbon atoms in the repeating unit, and (II) a divalent metal alcoholate.

The present invention relates to a composition comprising an aliphatic polyester-based resin and a divalent metal alcoholate, an article made of said composition as well as a method for improving the heat resistance of an aliphatic polyester-based resin.

Polyester compositions are described in e.g. U.S. Pat. No. 4,670,498, U.S. Pat. No. 5,110,849 and US-A-2006/0,142,505. Some divalent metal alcoholates are disclosed in e.g. US-A-2007/0,244,233 and WO-A-92/09,549.

Due to their excellent combination of features such as processability, thermal and physical properties, and durability, resins such as polyethylene, polypropylene, polyvinyl chloride or polystyrene have been used for decades as base resins for the fabrication of articles in fields as various as automotive parts, construction materials, electrical appliances, packaging or medical devices. However, the outstanding durability of these polymers is associated with very slow degradation, which renders their disposal problematic and makes them exert an adverse influence on biological systems. Furthermore, because of their fossil origin, these polymers have limited resources, leading to always increasing risks and contingency issues regarding sourcing, and potentially increasing price.

These shortcomings have led to the development of biodegradable polymers and/or polymers made from renewable sources. As examples of such polymers, starch or biodegradable polyester resins can be mentioned. More specifically, biodegradable polyester such as polylactic acid, lactic acid/other aliphatic hydroxycarboxylic acid copolymers, aliphatic polyesters derived from aliphatic polyvalent alcohols and aliphatic polyvalent carboxylic acids, and copolymers containing these units, have been developed as biodegradable polymers (for example copolymers of 3-hydroxybutyric acid and 3-hydroxyvaleric acid, polycaprolactone, polybutylene succinate). These biodegradable polymers, when placed in the right conditions, degrade within several years, whereby large scale petroleum-based polymers such as polyethylene need up to centuries to achieve similar degradation states, with consequential negative impact on nature. The decomposition products of biodegradable polymers are for instance lactic acid, carbon dioxide or water, and are not toxic to living beings.

Among aliphatic polyesters, polylactic acid (or polylactide) draws major interest because it can be produced at always more competitive prices, and because of its properties, such as high rigidity or transparency.

However, the heat stability of aliphatic polyester-based resins is not sufficient from the industrial point of view.

The present invention relates in particular to a composition comprising the components (I) an aliphatic polyester-based resin selected from the group consisting of polyhydroxyalkanoates with 3 to 8 carbon atoms in the repeating unit, and (II) a divalent metal alcoholate.

The aliphatic polyesters of this invention are either commercially available or can be obtained according to methods well known to the one skilled in the art; for example by polycondensation reaction of aliphatic hydroxy carboxylic acid or ring-opening polymerization.

Examples of aliphatic polyester resins obtained by polycondensation reaction of such aliphatic hydroxy carboxylic acids include polylactic acid, polyglycolic acid, poly-(3-hydroxybutyric acid), poly-(4-hydroxybutyric acid) and poly-(4-hydroxyvalerianic acid).

Examples of aliphatic polyester resins obtainable by ring-opening polymerization include polylactic acid, polypropiolactone, polybutyrolactone, polypivalolactone, polyvalerolactone and polycaprolactone.

Alternatively, the polylactic acid resin can be obtained by selecting a starting material having a structure of a lactide that is a cyclic lactic acid dimer, a glycolide that is a cyclic glycolic acid dimer, caprolactone, etc., and subsequent ring-opening polymerization of the starting material. The lactide can occur as a L-lactide that is a cyclic L-lactic acid dimer, a D-lactide that is a cyclic D-lactic acid dimer, a meso-lactide that is a cyclic dimer of D-lactic acid and L-lactic acid, and a DL-lactide that is a racemic mixture of D-lactide and L-lactide. In the present invention, any lactides can be used. However, the main starting material is preferably a D-lactide or a L-lactide.

The polylactic acid thus obtained may be formed by either a monomer unit derived from L-lactic acid or a monomer unit derived from D-lactic acid, or a copolymer of both units may be possible. Moreover, if the polylactic acid is a copolymer of the monomer unit derived from L-lactic acid and the monomer unit derived from D-lactic acid, the content of one of the monomer units is preferably 85 to about 100 mol %; 90 to about 100 mol % is more favorable; 95 to about 100 mol % is further more favorable; and 98 to about 100 mol % is particularly favorable. Particularly suitable polylactic acids are described in e.g. US-A-2006/142,505 which is incorporated by reference herein.

It is desired that the aliphatic polyesters are essentially free of remnant monomers. Thus, aliphatic polyester resins with a remnant monomer content of 5000 ppm or less are preferable, those containing 2000 ppm or less are more preferable, those containing 1000 ppm or less are even more preferable and those containing 500 ppm or less are still even more preferable.

The average molecular weight of the aliphatic polyester of this invention is not specifically limited. However, polyester resins with weight average molecular weight of 50 000 to 400 000 g/mol are preferable, those with 80 000 to 400 000 g/mol are more preferable and those with weight average molecular weight of 100 000-400 000 g/mol are even more preferable. (The weight average molecular weight of polymers is usually determined by light scattering according to ASTM D4001-93 (2006).)

Aliphatic polyester resins used herein include homopolymers obtained by using only one kind of aliphatic ester forming compound as the material and copolymers obtained by using one or more kinds of aliphatic ester forming compounds as well as mixtures of these homopolymers and copolymers. In terms of arrangements, these copolymers may be random copolymers, alternate copolymers, block copolymers or graft copolymers.

The aliphatic polyester is preferably a lactic-based polyester, in particular a polylactic acid.

A suitable polylactic acid is for example also a polylactic acid with high optical purity, containing preferably mainly L-lactic acid, with optionally 0.1 to 5% of D-lactic acid. Suitable grades of polylactic acid containing, for example, 1-2% of D-lactic acid, are commercially available for injection molding applications (e.g. from Nature Works LLC, Minnetonka, Minn.).

In the compositions according to the present invention also blends of an aliphatic polyester-based resin as defined above and another suitable polymer in a weight ratio of for example 1:100 to 100:1 can be applied.

Examples of said other polymer are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acry-lonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutylensuccinate/terephtalate, polybutyleneadipate/terephthalate, polytetramethyleneadipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example, glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lacide and any mixtures thereof.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

According to a preferred embodiment of the present invention, component (II) is the divalent metal alcoholate of a polyhydroxy (C₂-C₂₀ alkane). The metal is for example chosen among zinc, calcium, cobalt, boron, manganese, iron, magnesium, titanium or copper, in particular zinc, cobalt, boron, iron, titanium or copper.

The metal is in particular different from an alkaline earth metal.

The particle size of the divalent metal alcoholate is preferably such that 80% of the particles have a size of no more that 100 nm, as determined by laser light analysis.

The divalent metal alcoholate is in particular derived from polyhydroxy-(C₂-C₁₀alkane), for example ethylene glycol (=1,2-ethanediol) or glycerol (=1,2,3-propanetriol).

According to a particularly preferred embodiment, the divalent metal alcoholate is zinc glycerolate (CAS Registry No. 87189-25-1).

Micronized zinc glycerolate is particularly preferred.

The divalent metal alcoholate may be monomeric, oligomeric or polymeric, in particular polymeric.

The metal alcoholate is preferably a polymeric material formed by the reaction of a zinc compound and a polyhydroxy compound as described for example in U.S. Pat. No. 5,475,123 which is incorporated by reference herein.

The alcoholates are essentially known and commercially available or can be prepared according to known methods as described e.g. in U.S. Pat. No. 5,475,123 or U.S. Pat. No. 7,074,949. A commercially available suitable Zn glycerolate is for example Prifer 3881 (RTM) Zn glycerolate or Prifer 3888 (RTM) Nano sized Zn glycerolate.

According to a preferred embodiment 0.001 to 5%, in particular 0.01 to 2% or 0.05 to 1% of the metal alcoholate, relative to the weight of the aliphatic polyester-based resin, is present in the compositions of the instant invention.

The compositions of the present invention may optionally contain one or more conventional additives such as e.g. light stabilizers, heat stabilizers, processing aids, further nucleating agents, flame retardants, chemical blowing agent, colorants, pigments, reinforcement agents, plasticizers, fillers, and combinations thereof.

Examples of such conventional additives are:

### 1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1-yl)phenol, 2,4-dimethyl-6-(1-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3, 5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1, 3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethyl benzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

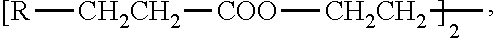

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyl-oxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.

2.5. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro-[4,5]decane, a reaction product of 7,7,9,9-tetramethyl-2-cycloundecyl-1-oxa-3,8-diaza-4-oxo-spiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl-1)-1,3,5-triazines, for example 2, 4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-[2-methyl-dibenz[d,g]-1,3,2-dioxaphosphocin, 2,2′,2″-nitrilo-[triethyltris(3,3′, 5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

Some structures are shown below:

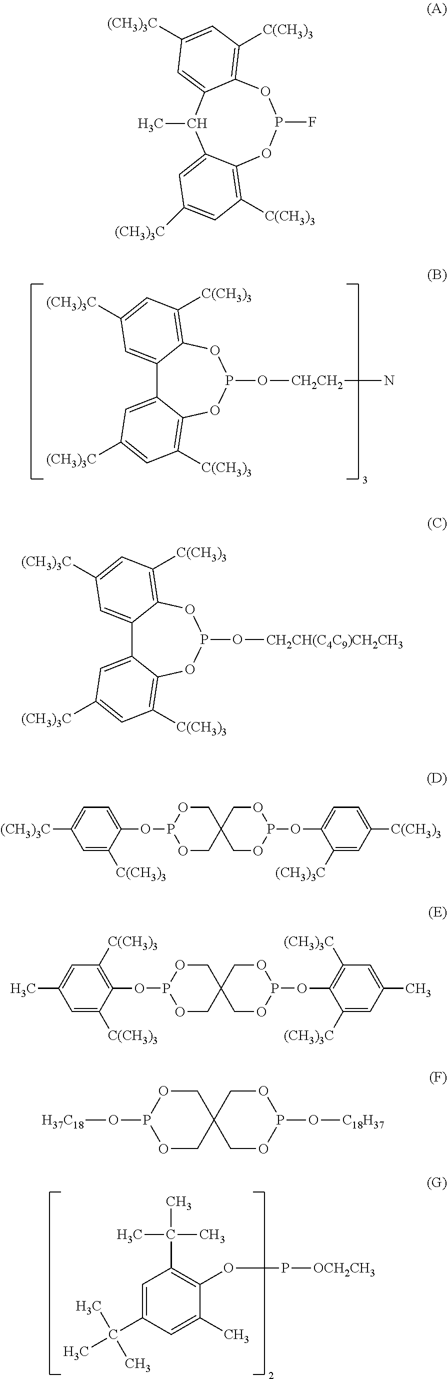

The above structures (D) and (G) as well as tris(2,4-di-tert-butylphenyl)phosphite and tetrakis(2,4-di-tert-butylphenyl)[1,1-biphenyl]-4,4′diylbisphosphonite are particularly preferred.

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, distearyl thiodipropionate or distearyl disulfide.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, preferably organophosphates containing dioxaphosphocin moieties, most preferably in form of their lithium, sodium and [Al(OH)]²⁺ salts, carbonates or sulfates of alkali metals, alkaline earth metals or mono-basic aluminum [Al(OH)]²⁺; organic compounds, such as mono- or polycarboxylic acids and derivatives thereof, e.g. 4-tert-butylbenzoic acid, 2,6-naphthalene-dicarboxylic acid, adipic acid, pimelic acid, subaric acid, diphenylacetic acid, succinic acid, trimesic acid, benzoic acid and any alkali metal or alkaline earth metal salt or any amide thereof; polymeric compounds, such as polyesters or ionic copolymers (ionomers), and, furthermore, bisacetals of polyols, like for example 1,3:2,4-bis(3′,4′-dimethylbenzylidene)sorbitol, 1,3:2,4-bis(paramethyl-dibenzylidene)sorbitol, and 1,3:2,4-di(benzylidene)sorbitol.

12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers; so-called nano-materials, very finely dispersed or exfoliated layer structures are particularly useful, as for example montmorillonite, bentonite and the like, as well as natural or synthetic nano-tube fillers like halloysites, zeolites or carbon-based nano-tubes or layer materials of the graphene or boron nitride type; preferred fillers are natural fibers, like for example, flax, kenaf, sisal, hemp, fibrous wood flour and the like as well as their combinations with any other fillers or fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl-benzofuran-2-one.

The content of a conventional additive being optionally present in the compositions according to the instant invention may be for example 0.001 to 10%, preferably 0.001 to 5%, relative to the weight of the aliphatic polyester-based resin.

A preferred embodiment of the present invention relates to a composition as defined above, containing additionally one or more conventional additives selected from the group consisting of

(III) a primary antioxidant, preferably one of those listed above under items 1.1, 1.5 and 1.11;
(IV) a metal deactivator, preferably one of those listed above under item 3;
(V) a secondary antioxidant, preferably a phosphite or phosphonite such as listed above under item 4;
VI) a filler, preferably one of those listed above under item 12; and
(VII) a pigment, e.g. carbon black or TiO₂.

The addition of the metal alcoholate (Component II) and optionally one or more further conventional additives to the aliphatic polyester (Component I) is conveniently carried out by standard procedures, well known to those skilled in the art, for example by compounding, such as mixing the prescribed components in a conventional mixer and melting and kneading the mixture with a single- or twin-screw extruder, or the like. Pre-compounding of the amount of additive with a reduced amount of aliphatic polyester, in form of a masterbatch, on a twin screw extruder, followed by compounding of the masterbatch with a higher amount of aliphatic polyester, has proven to give suitable results in terms of dispersion of the additive into the polymer matrix without thermally degrading the polymer. Processing under nitrogen blanket is preferable to avoid thermal degradation during compounding. Extrusion temperatures between 170° C. and 200° C., more preferably between 180° C. and 190° C. are advised. Lower temperature usually gives way to high pressure and low throughput. Temperatures above 200° C. should be avoided as much as possible in order to preserve the compound from thermal degradation. As aliphatic polyesters are subject to degradation by hydrolysis, pre-drying is recommended before each processing step. Pre-drying conditions known to the art are in the range of 60° C. to 90° C. for duration long enough to achieve a moisture content of 400 ppm or less, more preferably of 250 ppm or less, as measured by a Karl-Fischer titration method.

The temperatures to be used for injection molding should be preferably similar as the temperatures given above for extrusion. The molding time, which is defined as the lapse of time between the demolding of two successive parts, is preferably of 180 sec or shorter, for practical reasons and also to avoid leaving the compound during too a long time in the injection molding machine barrel at high temperature. More preferably the cycle time is 120 sec or shorter. The mold temperature is between the glass transition temperature and the melt temperature of the compound. The mold temperature is preferably high enough to provide enough enthalpy for polymer chain movement. The mold temperature is also preferably as low as possible to allow easy handling of the molded article and avoid deformation of the sample when demolding.

The compositions of the present invention are preferably semi-crystalline. In the case of polylactic acid, the degree of crystallinity can be calculated from the ratio of their enthalpy of crystallization to the enthalpy of crystallization of a pure polylactic acid crystal, corresponding to 100% crystallinity. A commonly accepted value for 100% crystallinity is 93.7 J/g (from G. Kolloid-Z., u. Z. Polym. 251 (1973), 980-990). The enthalpy of crystallization is evaluated by means of DSC (Differential Scanning Calorimetry), during the cooling step following melting, at a cooling rate of 20 K/min. Semi-crystalline in the present context means that the crystalline part is e.g. more than 10%, preferably 10 to 40%, in particular 30 to 50%. After melting, the composition should have adequate time for crystallization; in injection molding, this can be achieved e.g. by a sufficiently high mold temperature. Preferably, the difference between the melting point of the polyester-based resin and the mold temperature is about 40° to 90° C.

If desired, post-annealing of specimens, which have been injection molded into a room temperature mold, can be carried out; preferably at elevated temperature, more preferably above the glass transition temperature and below the melting temperature of the polyester-based resin, most preferably 10-25° C. above glass transition temperature and 20-35° C. below the melting temperature of the polyester-based resin.

The compositions according to the present invention have preferably a heat distortion temperature according to ISO 75-B (load 0.45 MPa) of more than 90° C., preferably 110° to 130° C. Even higher heat distorsion temperatures can be achieved by the use of the components claimed in the present invention and further additives, preferably fillers, fibers, peroxide, or poly(D-lactic acid).

Further, the instant invention relates to shaped articles, in particular all molded or extruded articles containing the present composition.

Typical processing methods for aliphatic polyesters include thermoforming, extrusion, blow molding, and injection molding.

The shaped article is preferably a film, sheet, fiber, profile, pipe, bottle, tank or a container.

The film may also be biaxially oriented.

The invention serves to provide articles based on aliphatic polyester with improved heat stability. The benefits of the invention can be used for applications including:

Automotive parts such as bumpers, radiator grills, side chenille, garnishing, wheel covers, aero parts, instrument panels, door trims, air bag covers rear and front linings seat fabrics, door handles, seat backing cladding, pillar covers luggage/roof racks and floor mats.

Further applications may include housings for various household electrical equipments, water-resistant sheets, containers of all sorts and bottles.

Furthermore, for using the molded article of the present invention as a sheet, paper or other polymer sheet is laid on the molded article, and the resultant may be used as a layered product with a multilayer structure.

Appliances, cases and coverings in general and electric/electronic devices (personal computer, telephone, portable phone, printer, television-sets, audio and video devices), flower pots, satellite TV bowl, and panel devices. Electric appliances, in particular washing machines, tumblers, ovens (microwave oven), dish-washers, mixers, and irons.

Devices for the electronic industry, in particular insulation for plugs, especially computer plugs, cases for electric and electronic parts, printed boards, and materials for electronic data storage such as chips, check cards or credit cards.

Foils for condensers, refrigerators, heating devices, air conditioners, encapsulating of electronics, semi-conductors, coffee machines, and vacuum cleaners.

Rotor blades, ventilators and windmill vanes, dividing walls, slat walls, folding walls, roofs, shutters (e.g. roller shutters), fittings.

Sanitary articles, in particular shower cubicles, lavatory seats, covers, and sinks. Hygienic articles, in particular brushes, mats, tubs, mobile toilets, tooth brushes, and bed pans.

Profiles of any geometry (window panes) and siding.

Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.

Hand rails, banisters, kitchen work tops, roofing, roofing sheets, tiles, and tarpaulins. Plates (walls and cutting board), trays.

Food packing and wrapping, medical packaging, carpets, centre console, dashboard, cockpits, door, overhead console module, door trim, headliners, interior lighting, interior mirrors, parcel shelf, rear luggage cover, seats, steering column, steering wheel, textiles, and trunk trim.

Storage systems such as boxes (crates), luggage, chest, household boxes, pallets, shelves, tracks, screw boxes, packs, and cans. Cartridges, medical applications, containers for any transportation, waste baskets and waste bins, waste bags, bins, dust bins, bin liners, wheely bins, container in general, crates, battery cases, troughs, medical devices such as piston, ophthalmic applications, diagnostic devices.

Kitchen ware (eating, drinking, cooking, storing).

Office supplies of any kind (ball-point pens, stamps and ink-pads, mouse, shelves, tracks), bottles of any volume and content (drinks, detergents, cosmetics including perfumes), and adhesive tapes.

Crates, electrical appliances, kitchen ware, food containers, drink bottles, garden furniture, washing machine components and automotive parts are also of interest.

Further embodiments of the present invention are:
A method for improving the dimensional stability of a shaped article made of an aliphatic polyester-based resin selected from the group consisting of polyhydroxyalkanoates with 3 to 8 carbon atoms in the repeating unit, which method comprises incorporating into the aliphatic polyester-based resin a divalent metal alcoholate before shaping.
A method for improving the heat resistance of an aliphatic polyester-based resin selected from the group consisting of polyhydroxyalkanoates with 3 to 8 carbon atoms in the repeating unit, which method comprises incorporating into the aliphatic polyester-based resin a divalent metal alcoholate.
A method for increasing the crystallization rate of an aliphatic polyester-based resin selected from the group consisting of polyhydroxyalkanoates with 3 to 8 carbon atoms in the repeating unit, which method comprises incorporating into the aliphatic polyester-based resin a divalent metal alcoholate.
The use of a divalent metal alcoholate as nucleating agent for an aliphatic polyester-based resin selected from the group consisting of polyhydroxyalkanoates with 3 to 8 carbon atoms in the repeating unit.

The examples below illustrate the invention in greater detail. All percentages and parts are by weight, unless stated otherwise.

### Test Procedures:

Melt Flow Rate (MFR) measurements are done in accordance with ISO 1133/ASTM D1238 (230° C./2.16 kg).

Heat Distortion Temperature (HDT) measurement is performed in accordance with ISO 75-B (load 0.45 MPa). The average of values of three specimens is calculated.

Crystallization Temperature (Tc) is determined using a differential scanning calorimeter (DSC), with two different methods.

Method A: A part of the molded sample (10 to 20 mg) is heated from 30° C. to 200° C. at a heating rate of 20° C./min, the isotherm at 200° C. is maintained during 5 minutes and the sample is cooled down from 200° C. to 30° C. at a rate of 20° C./min. The isotherm at 30° C. is maintained during 5 minutes and the sample is again heated to 200° C. and cooled down to 30° C., at the same rates as above stated. All measurements take place under nitrogen flow.

Method B: A part of the molded sample (10 to 20 mg) is heated from 30° C. to 200° C. at a heating rate of 10° C./min, the isotherm at 200° C. is maintained during 3 minutes and the sample is cooled down from 200° C. to 160° C. at a rate of 10° C./min, then from 160° C. to 70° C. at a rate of 0.5° C./min, then from 70° C. to 30° C. at a rate of 10° C./min. The sample is again heated from 30° C. to 240° C. at a rate of 10° C./min.

In both cases, the crystallization temperature Tc is defined as the peak temperature obtained during the cooling phase (i.e. from 200° C. to 30° C.). The enthalpy dHc (in J/g) of the corresponding peak is also recorded.

### EXAMPLE 1

### Preparation of the Article

Polylactic acid with MFR=8 g/10 min at 190° C. and 2.16 kg, melt temperature 170° C., is pre-dried at 80° C. during 16 hours under vacuum and nitrogen flow. The masterbatch consisting of polylactic acid and zinc glycerolate is extruded on a twin screw compounder (co-rotating screws, L/D=25) under nitrogen blanket. The melt temperature is 200° C.±3° C.

The hereinabove mentioned masterbatch is pre-dried at 70° C. during 16 hours under vacuum and nitrogen flow, and compounded on a twin screw extruder(co-rotating screws, L/D=33) under nitrogen flow, with melt temperature at 175-180° C., at a concentration chosen to obtain 1% zinc glycerolate in the composition of the extrudate.

The extrudate is pre-dried at 70° C. during 16 hours under vacuum and nitrogen flow, injection molded, on a machine with 500 kN clamping force, into specimens as specified in ISO 3167 (with overall length 170 mm and thickness 4 mm). The temperature at the nozzle is 190° C. and the mold temperature is set at 110° C., as listed in Table 1. The holding time is 180 seconds.

### Comparison:

The method described above is repeated except that no masterbatch and no compounding are necessary. The polylactic acid is used without additive. The other parameters are unchanged.

TABLE 1

| | | Mold temperature | HDT | Tc (° C.) | Tc (° C.) | dHc (J/g) | dHc (J/g) |
|---|---|---|---|---|---|---|---|
| Example | Additive | (° C.) | (° C.) | Method A | Method B | Method A | Method B |
| 1 | 1% of Zinc | 110 | 125 | 102 | 130 | 30 | 49 |
| | glycerolate | | | | | | |
| Comparison | None | 110 | 54 | — | 113 | 0 | 40 |

Example 1 illustrates a high increase of heat distortion temperature with the addition of zinc glycerolate as compared to the corresponding figure of the specimen of the Comparative Example.

1. A composition comprising the components
(I) an aliphatic polyester-based resin selected from the group consisting of polyhydroxyalkanoates with 3 to 8 carbon atoms in the repeating unit, and
(II) a divalent metal alcoholate.

2. A composition according to claim 1, wherein component (I) is a lactic-based polyester.

3. A composition according to claim 1, wherein component (I) is a polylactic acid.

4. A composition according to claim 1, wherein component (II) is a divalent metal alcoholate of a polyhydroxy(C₂-C₂₀alkane).

5. A composition according to claim 1, wherein the divalent metal is zinc, calcium, cobalt, boron, manganese, iron, magnesium, titanium or copper.

6. A composition according to claim 1, wherein component (II) is a divalent metal alcoholate of ethylene glycol (=1,2-ethanediol) or glycerol (=1,2,3-propanetriol).

7. A composition according to claim 1, wherein component (II) is a zinc glycerolate.

8. A composition according to claim 1, wherein component (II) is present in an amount of 0.001 to 5%, relative to the weight of component (I).

9. A composition according to claim 1, which has a heat distortion temperature above 90° C.

10. A composition according to claim 1, containing additionally one or more conventional additives selected from the group consisting of
(III) a primary antioxidant,
(IV) a metal deactivator,
(V) a secondary antioxidant,
(VI) a filler and
(VII) a pigment.

11. A shaped article made of a composition according to claim 1.

12. A shaped article according to claim 11, which is a molded or thermoformed article.

13. A shaped article according to claim 11, which is a film, sheet, fiber, profile, pipe, bottle, tank or a container.

14. A shaped article according to claim 11, which is an automotive part.

15. A method for improving the dimensional stability of a shaped article made of an aliphatic polyester-based resin selected from the group consisting of polyhydroxyalkanoates with 3 to 8 carbon atoms in the repeating unit, which method comprises incorporating into the aliphatic polyester-based resin a divalent metal alcoholate before shaping.

16. A method for improving the heat resistance or for increasing the crystallization rate of an aliphatic polyester-based resin selected from the group consisting of polyhydroxyalkanoates with 3 to 8 carbon atoms in the repeating unit, which method comprises incorporating into the aliphatic polyester-based resin a divalent metal alcoholate.

17. (canceled)

18. (canceled)
